(19) United States
(12) Patent Application Publication
(10) Pub. No.: US 2023/0111397 A1
(43) Pub. Date: Apr. 13, 2023

(54) ORAL TRAY AND METHOD

(71) Applicant: Caroline M. Girard, Pasadena, CA (US)

(72) Inventor: Caroline M. Girard, Pasadena, CA (US)

(21) Appl. No.: 17/572,462

(22) Filed: Jan. 10, 2022

Related U.S. Application Data
(63) Continuation of application No. 17/497,777, filed on Oct. 8, 2021.

(51) Int. Cl. A61C 19/06

(52) U.S. Cl. CPC A61C 19/066

(57) ABSTRACT

An oral tray for conditioning teeth within a mouth of a user includes a first tray layer and a second tray layer. The first tray layer is configured to engage teeth within the mouth of the user. The first tray layer can have a first Young's modulus of greater than 0.60 and less than 1.50. The first tray layer can have a first tray thickness of greater than 0.40 mm and less than 0.90 mm. The second tray layer is coupled to the first tray layer. The second tray layer has a plurality of tooth portions each including a recess. Each recess is configured to receive a tooth conditioner. The second tray layer can have a second Young's modulus of greater than 0.02 and less than 0.30. The second tray layer can have a second tray thickness of greater than 0.80 mm and less than 1.30 mm.

### RELATED APPLICATION

This continuation application claims priority on U.S. application Ser. No. 17/497,777, filed on Oct. 8, 2021, and entitled “ORAL TRAY AND METHOD”. As far as permitted, the contents of U.S. application Ser. No. 17/497,777 are incorporated in their entirety herein by reference.

### BACKGROUND

Cosmetic teeth whitening is often ineffective due to unstable coloring, generalized tooth sensitivity from the whitening products, and decreased enamel micro-hardness due to the acidic properties of whitening products—many consumers about whitening treatments due to teeth sensitivity and enamel-related health concerns. Various conventional devices used for cosmetic teeth whitening are also unsuccessful because they are unable to properly seal out saliva when in use. Saliva can contaminate the whitening products, thereby deactivating the whitening properties within a short time after contact with the saliva.

### SUMMARY

The present invention is directed toward an oral tray for the conditioning of teeth within a mouth of a user. In various embodiments, the oral tray includes a first tray layer and a second tray layer. The first tray layer is configured to engage the teeth within the mouth of the user. The second tray layer is coupled to the first tray layer. The second tray layer having a plurality of tooth portions each including a recess, each recess being configured to receive a tooth conditioner.

In some embodiments, when the oral tray is in contact with the teeth of the user, each recess is configured to be positioned greater than 0.1 mm from a gum line in the mouth of the user.

In certain embodiments, each recess is configured to form a compartment with a corresponding tooth when the oral tray is in contact with the teeth of the user.

In various embodiments, when the oral tray is in contact with the teeth of the user, each compartment has a compartment width of greater than 0.1 mm between the recess and one corresponding tooth of the plurality of teeth.

In some embodiments, the recess has a recess perimeter that is configured to be positioned greater than 0.1 mm from an outer perimeter of at least some of the teeth.

In certain embodiments, the first tray layer is formed at least partially from a plastic material.

In various embodiments, the first tray layer is formed at least partially from a polypropylene.

In some embodiments, the second tray layer is formed at least partially from a plastic material.

In certain embodiments, the second tray layer is formed at least partially from an ethylene-vinyl acetate.

In various embodiments, the first tray layer is configured so that the second tray layer contacts at least a portion of an occlusal plane of the teeth of the user.

In some embodiments, each tooth includes a face. The teeth of the user include molars and non-molars. The oral tray can be configured so that only the second tray layer contacts a plurality of faces of non-molars of the teeth of the user.

In certain embodiments, the oral tray can be configured so that the first tray layer is in contact with a portion of at least one molar of the teeth of the user.

In various embodiments, the first tray layer can have a Young's modulus of greater than 0.50 and less than 2.00.

In some embodiments, the second tray layer can have a Young's modulus of greater than 0.01 and less than 0.40.

In certain embodiments, the first tray layer can have a first Young's modulus that is greater than a second Young's modulus of the second tray layer.

In various embodiments, the first tray layer can have a first Young's modulus and the second tray layer has a second Young's modulus so that a ratio of the first Young's modulus to the second Young's modulus is at least approximately 5:4.

In some embodiments, the first tray layer can have a first tray thickness of greater than 0.01 mm and less than 2.00 mm.

In certain embodiments, the second tray layer can have a second tray thickness of greater than 0.01 mm and less than 2.00 mm.

In various embodiments, the first tray layer can have a first tray thickness and the second tray layer has a second tray thickness so that a ratio of the second tray thickness to the first tray thickness is at least approximately 1:1.

The present invention is further directed toward an oral tray for conditioning of teeth within a mouth of a user. In various embodiments, the oral tray includes a first tray layer and a second tray layer. The first tray layer is configured to engage the teeth within the mouth of the user. The first tray layer has a first Young's modulus of greater than 0.60 and less than 1.50. The first tray layer has a first tray thickness of greater than 0.40 mm and less than 0.90 mm. The second tray layer is coupled to the first tray layer. The second tray layer has a plurality of tooth portions each including a recess. Each recess is configured to receive a tooth conditioner. The second tray layer has a second Young's modulus of greater than 0.02 and less than 0.30. The second tray layer has a second tray thickness of greater than 0.80 mm and less than 1.30 mm.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified front perspective illustration of an oral tray and a model of a portion of a user's mouth of an embodiment having features of the present invention;

FIG. 2 is a simplified cross-sectional view illustration of the oral tray and the model taken on line 2-2 in FIG. 1;

FIG. 3 is a simplified cross-sectional view illustration of the oral tray and the model taken on line 3-3 in FIG. 1, the oral tray retaining a tooth conditioner;

FIG. 4 is a simplified cross-sectional view illustration of the oral tray taken on line 4-4 in FIG. 1;

FIG. 5A is a simplified rear perspective view of a portion of the oral tray;

FIG. 5B is a simplified top view of the portion of the oral tray shown in FIG. 5A;

FIG. 6 is a top view of an impression tray and an impression material used by one embodiment of a method for manufacturing the oral tray;

FIG. 7 is a front perspective view of another impression tray and an impression material used by one embodiment of a method for manufacturing the oral tray;

FIG. 8 is a front perspective view of a completed model of a user's mouth used by one embodiment of a method for manufacturing the oral tray;

FIG. 9 is a front view of a model of a user's mouth including a plurality of spacers used by one embodiment of a method for manufacturing the oral tray;

FIG. 10A is a simplified front view of a model of a user's mouth including a plurality of spacers used by one embodiment of a method for manufacturing the oral tray;

FIG. 10B is a simplified cross-sectional view illustration of the model of the user's mouth taken on line 10B-10B in FIG. 10A;

FIG. 11 is a flowchart outlining one embodiment of a method for manufacturing the oral tray;

FIG. 12 is a flowchart outlining one embodiment of a method for conditioning of a user's teeth; and

FIG. 13 is a flowchart outlining one embodiment of a method for manufacturing the oral tray.

While embodiments are susceptible to various modifications and alternative forms, specifics thereof have been shown by way of example and drawings, and will be described in detail. It should be understood, however, that the scope herein is not limited to the particular aspects described. On the contrary, the intention is to cover modifications, equivalents, and alternatives falling within the spirit and scope herein.

### DESCRIPTION

Embodiments of the present invention are described herein in the context of an oral tray, a method of manufacturing the oral tray, and a method for the conditioning of teeth. In particular, the oral trays are uniquely designed and/or are uniquely formed to overcome issues of tooth conditioning of the past, including issues of leaking conditioning substances. For example, as provided herein, the oral tray can incorporate a plurality of layers that can provide various benefits and advantages for the users wearing the oral tray. Additionally, advantages are granted to oral healthcare and cosmetic professionals who are providing such oral trays.

Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention, as illustrated in the accompanying drawings. The same or similar nomenclature and/or reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-related and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

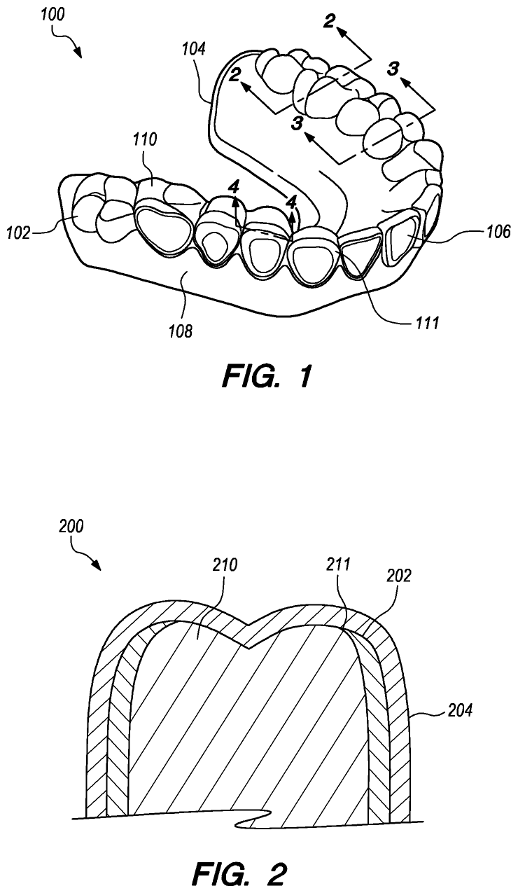

FIG. 1 is a simplified front perspective illustration of an oral tray 100 and a model 108 of a portion of a user's mouth (not shown) of an embodiment having features of the present invention. More particularly, as shown, the oral tray 100 is configured to engage the model 108 of the portion of the user's mouth. Alternatively, when the model 108 is uncoupled from the oral tray 100, the oral tray 100 is configured to engage a plurality of teeth within the mouth of the user (not shown).

As used herein, “coupled” can be understood to mean, without limitation, one or more of the following: attached (selectively and/or removably), bolted, constrained to, engaged (mutually and/or unilaterally), fixed, integrally formed with, interlocked, locked, mated, mounted (pivotally and/or rotatably), secured, set, joined, linked, welded or otherwise connected. It is appreciated that the coupling can be permanent or temporary.

The oral tray 100 can be used by users for tooth conditioning. As used herein, “conditioning” can be understood to mean, without limitation, one or more of the following: whitening, strengthening, cleaning, and/or desensitizing. As used herein, “conditioners” can be understood to mean, without limitation, any substance and/or composition that can be utilized by the oral tray 100 to attain the objective of the conditioning (e.g., whitening, strengthening, enamel hardening, cleaning, etc.). In some embodiments, the oral tray 100 can function as a retainer, a grinder guard, an athletic mouth guard, and/or a clench guard. For example, the oral tray 100 can be used to protect the user's temporomandibular joint during grinding and/or clenching. The oral tray 100 can be used by the user for any number of hours and during any activity, including sleep. The oral tray 100 can be configured to condition the user's teeth and/or mouth for any number of years, months, weeks, days, hours, minutes, or seconds. As a result, by using the oral tray 100, the user can achieve improved oral health, teeth whitening, and/or teeth conditioning.

The oral tray 100 can vary depending on the design requirements. It is understood that the oral tray 100 can include additional components, systems, subsystems, and elements other than those specifically shown and/or described herein. Additionally, or alternatively, the oral tray 100 can omit one or more of the components, systems, subsystems, and elements that are specifically shown and/or described herein. In some embodiments, various components of the oral tray 100 can be positioned differently than what is specifically illustrated in FIG. 1.

As illustrated in the embodiment depicted in FIG. 1, the oral tray 100 can include a first tray layer 102, a second tray layer 104, and a recess 106. While only one oral tray 100 is depicted in FIG. 1, it is understood that the oral tray 100 can be formed and/or customized for the upper teeth and the lower teeth of any individual user. The oral tray 100 can also include any suitable number of layers and/or recesses 106.

In other embodiments, as described herein, various layers and/or components of the oral tray 100 (such as the first tray layer 102, the second tray layer 104, and/or the plurality of recesses 106) and/or the specific components included therewith can be formed from nylon-based materials such as PA2200 nylon, polyamide 12 nylon, or other suitable nylon-based materials. In certain embodiments, various layers and/or components of the oral tray 100 (such as the first tray layer 102, the second tray layer 104, and/or the plurality of recesses 106) and/or the specific components included therewith can be at least partially formed from printable resins and/or any suitable printable material.

The oral tray 100 can be quickly and easily made and/or remade without the need for additional models or impressions being formed, which can otherwise greatly slow down the overall conditioning processes. Additionally, in various embodiments, the use of flexible printed materials can allow less bulky fabrication of the oral tray 100.

The first tray layer 102 can form the base and/or support structure of the oral tray 100. The first tray layer 102 can engage one or more teeth within the mouth of the user (not shown). The first tray layer 102 can vary depending on the design requirements of the oral tray 100. It is understood that the first tray layer 102 can include additional components, systems, subsystems, and elements other than those specifically shown and/or described herein. Additionally, or alternatively, the first tray layer 102 can omit one or more of the components, systems, subsystems, and elements that are specifically shown and/or described herein.

The first tray layer 102 can be formed from using any suitable material for oral use including both synthetic and natural materials. In some embodiments, the first tray layer 102 can be at least partially formed from a polymer material and/or a plastic material, including flexible and inflexible plastics. In some such embodiments, the plastic material can include polypropylene or the like. In other embodiments, the first tray layer 102 can be formed from an ethylene-vinyl acetate or any other suitable plastic material. In certain embodiments, the first tray layer 102 can be at least partially formed from printable resins and/or any suitable printable material.

The first tray layer 102 can be trimmed to increase the retentiveness of the oral tray 100 by precluding deformation under occlusal forces or tongue movement within the mouth of the user. The first tray layer 102 can be formed to be similar in form and/or function to a traditional retainer, allowing for increased retentiveness around the teeth of the user. The various layers and/or components of the oral tray 100 (such as the first tray layer 102, the second tray layer 104, and/or the recess 106) and/or the specific components included therewith can be trimmed using any suitable trimming methods known in the art.

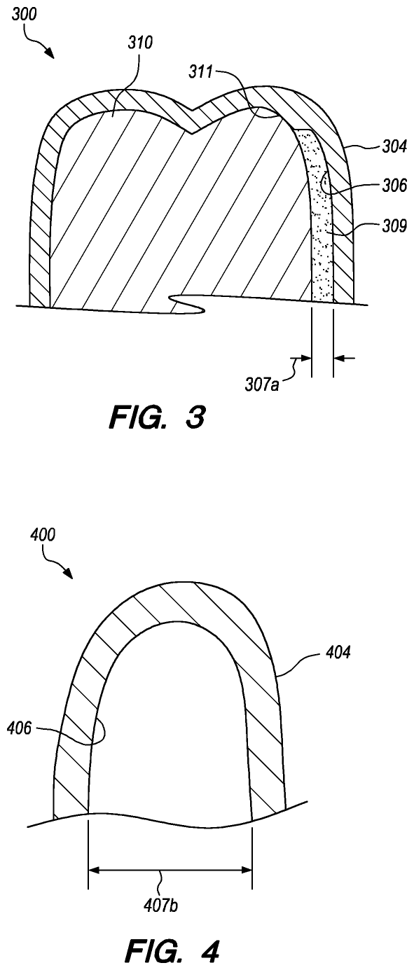

The second tray layer 104 can be coupled to, secured directly to, bonded to, or otherwise connected directly or indirectly to the first tray layer 102. In certain embodiments, the first tray layer 102 and the second tray layer 104 can be integrally formed or formed as a unitary structure. The second tray layer 104 can engage one or more of the teeth within the mouth of the user. In one embodiment, the second tray layer 104 can be formed over the first tray layer 102 so that the first tray layer 102 is only exposed on one side. The second tray layer 104 can cooperate with a plurality of teeth within the mouth of the user (not shown) so that a compartment (shown with a compartment width 307a in FIG. 3 and a compartment length 407b in FIG. 4) is formed between a portion of one or more of the plurality of teeth 110 (e.g., the tooth face 111) and the recess 106. In some embodiments, the compartment is formed at the location of the recess 106 and the tooth face 111. In other words, the compartment forms the empty space between the tooth face 111 and the recess 106 when the second tray layer 104 is in contact with the plurality of teeth.

The second tray layer 104 can vary depending on the design requirements of the oral tray 100 and/or the first tray layer 102. It is understood that the second tray layer 104 can include additional components, systems, subsystems, and elements other than those specifically shown and/or described herein. Additionally, or alternatively, the second tray layer 104 can omit one or more of the components, systems, subsystems, and elements that are specifically shown and/or described herein.

The second tray layer 104 can be formed from using any suitable material for oral use, including synthetic and natural materials. In some embodiments, the second tray layer 104 can be at least partially formed from a polymer material and/or a plastic material, including flexible and inflexible plastics. In various embodiments, the second tray layer 104 can be formed from ethylene-vinyl acetate, polypropylene, or another suitable plastic material. In certain embodiments, the second tray layer 104 can be at least partially formed from printable resins and/or any suitable printable material.

The second tray layer 104 can be trimmed so that the oral tray 100 is scalloped around a gum line of the mouth of the user. As used herein, “scalloped” is understood to mean cut into curves and/or notches in order to conform to an edge or a border. In other embodiments, the second tray layer 104 can be trimmed to be substantially straight in relation to the gum line of the mouth of the user (not shown). The second tray layer 104 can include a tooth portion that can contact a portion of the tooth 110 (e.g., the tooth face 111).

In various embodiments, by coupling the second tray layer 104 with the first tray layer 102, the oral tray 100 can be formed as a bio-compatible dual-layer structure including a soft, cushioned exterior of the second tray layer 104 and a firm interior of the first tray layer 102 in order to provide the user with increased comfort and wear-ability while improving the durability of the oral tray 100. By this design, the oral tray 100 becomes sturdier and is less likely to deform when the user bites down on the oral tray 100. In some embodiments, the second tray layer 104 is more flexible than the first tray layer 102. In certain embodiments, the first tray layer 102 is more rigid than the second tray layer 104.

The first tray layer 102 and the second tray layer 104 can have varying levels of stiffness. In some embodiments, the first tray layer 102 and second tray layer 104 illustrated and described herein can each have a Young's modulus between approximately 0.01 and 6.00. In some such non-exclusive embodiments, the first tray layer 102 and second tray layer 104 can each have a Young's modulus of approximately 0.01, 0.10, 0.20, 0.30, 0.40, 0.50, 0.60, 0.70, 0.80, 0.90, 1.00, 1.10, 1.20, 1.30, 1.40, 1.50, 1.60, 1.70, 1.80, 1.90, 2.00, 2.10, 2.20, 2.30, 2.40, 2.50, 2.60, 2.70, 2.80, 2.90, 3.00, 3.10, 3.20, 3.30, 3.40, 3.50, 3.60, 3.70, 3.80, 3.90, 4.00, 4.10, 4.20, 4.30, 4.40, 4.50, 4.60, 4.70, 4.80, 4.90, 5.00, 5.10, 5.20, 5.30, 5.40, 5.50, 5.60, 5.70, 5.80, 5.90, or 6.00. In other embodiments, the first tray layer 102 and second tray layer 104 can each have a Young's modulus of greater than 6.00 or less than 0.01.

In various embodiments, the first tray layer 102 can have a first Young's modulus and the second tray layer 104 can have a second Young's modulus so that a ratio of the first Young's modulus to the second Young's modulus can be between approximately 5:4 and 6:1. In other non-exclusive embodiments, the ratio of the first Young's modulus to the second Young's modulus can be approximately 1:1, 1.05:1, 1.1:1, 1.15:1, 1.2:1, 1.25:1, 1.3:1, 1.35:1, 1.4:1, 1.45:1, 1.5:1, 1.55:1, 1.6:1, 1.65:1, 1.7:1, 1.75:1, 1.8:1, 1.85:1, 1.9:1, 1.95:1, 2:1, 2.05:1, 2.1:1, 2.15:1, 2.2:1, 2.25:1, 2.3:1, 2.35:1, 2.4:1, 2.45:1, 2.5:1, 2.55:1, 2.6:1, 2.65:1, 2.7:1, 2.75:1, 2.8:1, 2.85:1, 2.9:1, 2.95:1, 3:1, 3.05:1, 3.1:1, 3.15:1, 3.2:1, 3.25:1, 3.3:1, 3.35:1, 3.4:1, 3.45:1, 3.5:1, 3.55:1, 3.6:1, 3.65:1, 3.7:1, 3.75:1, 3.8:1, 3.85:1, 3.9:1, 3.95:1, 4:1, 4.05:1, 4.1:1, 4.15:1, 4.2:1, 4.25:1, 4.3:1, 4.35:1, 4.4:1, 4.45:1, 4.5:1, 4.55:1, 4.6:1, 4.65:1, 4.7:1, 4.75:1, 4.8:1, 4.85:1, 4.9:1, 4.95:1, 5:1, 5.05:1, 5.1:1, 5.15:1, 5.2:1, 5.25:1, 5.3:1, 5.35:1, 5.4:1, 5.45:1, 5.5:1, 5.55:1, 5.6:1, 5.65:1, 5.7:1, 5.75:1, 5.8:1, 5.85:1, 5.9:1, 5.95:1, or 6:1. In certain embodiments, the ratio of the first Young's modulus to the second Young's modulus can be greater than approximately 6:1 or less than approximately 1:1.

The first tray layer 102 and the second tray layer 104 can have varying levels of thicknesses. In some embodiments, the first tray layer 102 and second tray layer 104 illustrated and described herein can each have a thickness of between approximately 0.01 mm and 2.00 mm . In some such non-exclusive embodiments, the first tray layer 102 and second tray layer 104 can each have a thickness of approximately 0.01 mm, 0.02 mm, 0.03 mm, 0.04 mm, 0.05 mm, 0.06 mm, 0.07 mm, 0.08 mm, 0.09mm, 0.1 mm, 0.11mm, 0.12 mm, 0.13 mm, 0.14 mm, 0.15 mm, 0.16 mm, 0.17 mm, 0.18 mm, 0.19 mm, 0.2 mm, 0.21 mm, 0.22 mm, 0.23 mm, 0.24 mm, 0.25 mm, 0.26 mm, 0.27 mm, 0.28 mm, 0.29 mm, 0.3 mm, 0.31 mm, 0.32 mm, 0.33 mm, 0.34 mm, 0.35 mm, 0.36 mm, 0.37 mm, 0.38 mm, 0.39 mm, 0.4 mm, 0.41 mm, 0.42 mm, 0.43 mm, 0.44 mm, 0.45 mm, 0.46 mm, 0.47 mm, 0.48 mm, 0.49 mm, 0.5 mm, 0.51 mm, 0.52 mm, 0.53 mm, 0.54 mm, 0.55 mm, 0.56 mm, 0.57 mm, 0.58 mm, 0.59 mm, 0.6 mm, 0.61 mm, 0.62 mm, 0.63 mm, 0.64 mm, 0.65 mm, 0.66 mm, 0.67 mm, 0.68 mm, 0.69 mm, 0.7 mm, 0.71 mm, 0.72 mm, 0.73 mm, 0.74 mm, 0.75 mm, 0.76 mm, 0.77 mm, 0.78 mm, 0.79 mm, 0.8 mm, 0.81 mm, 0.82 mm, 0.83 mm, 0.84 mm, 0.85 mm, 0.86 mm, 0.87 mm, 0.88 mm, 0.89 mm, 0.9 mm, 0.91 mm, 0.92 mm, 0.93 mm, 0.94 mm, 0.95 mm, 0.96 mm, 0.97 mm, 0.98 mm, 0.99 mm, 1 mm, 1.01 mm, 1.02 mm, 1.03 mm, 1.04 mm, 1.05 mm, 1.06 mm, 1.07 mm, 1.08 mm, 1.09 mm, 1.1 mm, 1.11 mm, 1.12 mm, 1.13 mm, 1.14 mm, 1.15 mm, 1.16 mm, 1.17 mm, 1.18 mm, 1.19 mm, 1.2 mm, 1.21 mm, 1.22 mm, 1.23 mm, 1.24 mm, 1.25 mm, 1.26 mm, 1.27 mm, 1.28 mm, 1.29 mm, 1.3 mm, 1.31 mm, 1.32 mm, 1.33 mm, 1.34 mm, 1.35 mm, 1.36 mm, 1.37 mm, 1.38 mm, 1.39 mm, 1.4 mm, 1.41 mm, 1.42 mm, 1.43 mm, 1.44 mm, 1.45 mm, 1.46 mm, 1.47 mm, 1.48 mm, 1.49 mm, 1.5 mm, 1.51 mm, 1.52 mm, 1.53 mm, 1.54 mm, 1.55 mm, 1.56 mm, 1.57 mm, 1.58 mm, 1.59 mm, 1.6 mm, 1.61 mm, 1.62 mm, 1.63 mm, 1.64 mm, 1.65 mm, 1.66 mm, 1.67 mm, 1.68 mm, 1.69 mm, 1.7 mm, 1.71 mm, 1.72 mm, 1.73 mm, 1.74 mm, 1.75 mm, 1.76 mm, 1.77 mm, 1.78 mm, 1.79 mm, 1.8 mm, 1.81 mm, 1.82 mm, 1.83 mm, 1.84 mm, 1.8 5mm, 1.86 mm, 1.87 mm, 1.88 mm, 1.89 mm, 1.9 mm, 1.91 mm, 1.92 mm, 1.93 mm, 1.94 mm, 1.95 mm, 1.96 mm, 1.97 mm, 1.98 mm, 1.99 mm, or 2 mm. In other embodiments, the first tray layer 102 and second tray layer 104 can each have a thickness of greater than approximately 2.00 mm or less than approximately 0.01 mm.

In certain embodiments, the first tray layer 102 can have a first thickness and the second tray layer 104 can have a second thickness so that a ratio of the second thickness to the first thickness illustrated and described herein can be between approximately 1:1 and 4:1. In other non-exclusive embodiments, the ratio of the second thickness to the first thickness can be approximately 1:1, 1.05:1, 1.1:1, 1.15:1, 1.2:1, 1.25:1, 1.3:1, 1.35:1, 1.4:1, 1.45:1, 1.5:1, 1.55:1, 1.6:1, 1.65:1, 1.7:1, 1.75:1, 1.8:1, 1.85:1, 1.9:1, 1.95:1, 2:1, 2.05:1, 2.1:1, 2.15:1, 2.2:1, 2.25:1, 2.3:1, 2.35:1, 2.4:1, 2.45:1, 2.5:1, 2.55:1, 2.6:1, 2.65:1, 2.7:1, 2.75:1, 2.8:1, 2.85:1, 2.9:1, 2.95:1, 3:1, 3.05:1, 3.1:1, 3.15:1, 3.2:1, 3.25:1, 3.3:1, 3.35:1, 3.4:1, 3.45:1, 3.5:1, 3.55:1, 3.6:1, 3.65:1, 3.7:1, 3.75:1, 3.8:1, 3.85:1, 3.9:1, 3.95:1, or 4:1. In certain embodiments, the ratio of the second thickness to the first thickness can be greater than approximately 4:1 or less than approximately 1:1.

The recess 106 can be formed in the second tray layer 104. The recess 106 can be angulated. The walls of the recess 106 can also be angulated. The recess 106 can be formed so that a sealing force is increased between the recess 106 and the teeth. Each of the recesses 106 is configured to retain a tooth conditioner (309 in FIG. 3). The recess 106 can be configured so they have a sealing force similar to that of a suction cup.

In certain embodiments, the recess 106 can be configured to inhibit the user's saliva from entering the compartment. Additionally, the recess 106 can be configured to decrease the probability of chemical disruptions to the tooth conditioner 309 retained in the compartment. By utilizing a dual-layer oral tray 100, the seal is less likely to break when the user bites down on the oral tray 100. The oral tray 100 can therefore be more effective for users who exhibit grinding and clenching of their teeth. As used herein, “recess” 106 can define the portion of the second tray layer 104 that does not contact the tooth 110 when a tooth portion of the second tray layer 104 is in contact with the tooth face 111.

The recess 106 can vary depending on the design requirements of the oral tray 100, the first tray layer 102, and/or the second tray layer 104. It is understood that the recess 106 can include additional components, systems, subsystems, and elements other than those specifically shown and/or described herein. Additionally, or alternatively, the recess 106 can omit one or more of the components, systems, subsystems, and elements that are specifically shown and/or described herein. When viewed in a cross-section (see FIG. 3 and FIG. 4), the recess 106 can have any suitable cross-sectional shape, including somewhat of a v-shape, a u-shape, an n-shape, a c-shape, I-shape, or an m-shape, as non-limiting, non-exclusive examples.

The recess 106 can be integrally formed with the second tray layer 104. In other embodiments, the recess 106 can be separately coupled to the second tray layer 104 and/or the first tray layer 102. The recess 106 can be formed to have a straight edge, a curved edge, and/or a bowed edge.

A model 108 can be formed to represent a portion of the user's mouth including a plurality of the user's teeth. The model 108 can be utilized to manufacture the oral tray 100 (to be described in further detail herein). As illustrated in FIG. 1, the oral tray 100 can be configured to be coupled to the model 108.

The model 108 can vary depending on the design requirements of the oral tray 100 and/or the inner dimensionality of the user's mouth and/or teeth. It is understood that the model 108 can include additional components, systems, subsystems, and elements other than those specifically shown and/or described herein. Additionally, or alternatively, the model 108 can omit one or more of the components, systems, subsystems, and elements that are specifically shown and/or described herein. The model 108 can include a plurality of teeth 110 and a portion of the gums of the user's mouth.

The teeth 110 can each include a tooth face 111. The teeth 100 of the user (or model 108) include molars and non-molars. In some embodiments, the oral tray 100 is configured so that only the second tray layer 104 contacts a plurality of tooth faces 111 of non-molars of the teeth 110 of the user (or model 108).

The recess 106 can cover the tooth face 111 at any suitable percentage so that an increased sealing force is created around a perimeter of the recess 106 and the tooth face 111. In some embodiments, the recess 106 can cover approximately 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% of the tooth face 111. In other embodiments, the recess 106 can cover greater than approximately 99% of tooth face 111 or less than approximately 1% of the tooth face 111.

The figures and drawings included herein are not necessarily to scale. For ease of understanding, there is a margin between the perimeter of each recess 106 and the outer circumference of each corresponding tooth face 111. It is appreciated that the margin between the perimeter of each recess 106 and the outer circumference of each corresponding tooth face 111 can vary. In other embodiments, the recess 106 can align with the outer circumference of the tooth 110 so that no margin exists between the perimeter of each recess 106 and the outer circumference of the corresponding tooth face 111.

The margin between the perimeter of each recess 106 and the outer circumference of each corresponding tooth face 111 can be as large or as small as needed to meet the design requirements of the oral tray 100. For example, the margin between each the perimeter of each recess 106 and the outer circumference of each corresponding tooth 110 can be large enough to create an increased sealing force between the perimeter of each recess 106 and the outer circumference of each corresponding tooth 110, resulting in a decreased likelihood that saliva enters the recess 106. In other words, the recess 106 is designed to decrease the likelihood and/or inhibit the leakage of saliva into the recess 106.

FIG. 2 is a simplified cross-sectional view illustration of the oral tray 200 and the model 108 including one tooth 210 taken on line 2-2 in FIG. 1. In the embodiment displayed in FIG. 2, greater detail of the dual-layer oral tray 200 is shown. The tooth 210 can be substantially surrounded by both the first layer 202 and the second layer 204.

In some embodiments, such as shown in FIG. 2, the first layer 202 can partially wrap around the tooth 210 so that a portion of the tooth 210 (e.g., the occlusal plane) is in contact with only the second layer 204. In certain embodiments, the first layer 202 can be configured to be a structural support layer for the oral tray 200, and the second layer 204 can be configured to be a sealing layer between the recess 106 and the tooth 210. The teeth 210 can each include a tooth face 211.

FIG. 3 is a simplified cross-sectional view illustration of the oral tray 300 and the model 108 including one tooth 310 taken on line 3-3 in FIG. 1. In FIG. 3, the oral tray 300 is shown in a retaining state where a tooth conditioner 309 is retained in the compartment defined by the recess 306 and the tooth face 311. As shown in the embodiment illustrated in FIG. 3, certain portions of the oral tray 300 may only include one layer, such as the second tray layer 304 or the first tray layer 102. In addition, the compartment defined by the recess 306, the second tray layer 304, the tooth 310, and the tooth face 311 are shown in greater detail in FIG. 3. In particular, as shown in FIG. 3, the compartment can have a compartment width 307a.

The compartment width 307a can vary depending on the design requirements of the oral tray 300, the recess 306, and/or the tooth conditioner 309. The compartment width 307a between the second tray layer 304 and each of the plurality of teeth at the location of the recesses 306 illustrated and described herein can be between approximately 0.01 mm and 3.00 mm. In various non-exclusive, alternative embodiments, the compartment width 307a can be approximately 0.01 mm, 0.05 mm, 0.10 mm, 0.15 mm, 0.20 mm, 0.25 mm, 0.30 mm, 0.35 mm, 0.40 mm , 0.45 mm, 0.50 mm, 0.55 mm, 0.60 mm, 0.65 mm, 0.70 mm, 0.75 mm, 0.80 mm, 0.85 mm, 0.90 mm, 0.95 mm, 1.00 mm, 1.05 mm, 1.10 mm, 1.15 mm, 1.20 mm, 1.25 mm, 1.30 mm, 1.35 mm, 1.40 mm, 1.45 mm, 1.50 mm, 1.55 mm, 1.60 mm, 1.65 mm, 1.70 mm, 1.75 mm, 1.80 mm, 1.85 mm, 1.90 mm, 1.95 mm, 2.00 mm , 2.05 mm, 2.10 mm, 2.15 mm, 2.20 mm, 2.25 mm, 2.30 mm, 2.35 mm, 2.40 mm, 2.45 mm, 2.50 mm, 2.55 mm, 2.60 mm, 2.65 mm, 2.70 mm, 2.75 mm, 2.80 mm, 2.85 mm, 2.90 mm, 2.95 mm, or 3.00 mm. In other embodiments, the compartment width 307a can be greater than approximately 3.00 mm or less than approximately 0.01 mm.

FIG. 4 is a simplified cross-sectional view illustration of the oral tray 400 taken on line 4-4 in FIG. 3. The compartment defined by the recess 406, the second tray layer 404, and the tooth face 111, is shown in greater detail in FIG. 4. The dimensions of the compartment defined by the recess 406, the second tray layer 404, and the tooth face 111 can vary and have been simplified in the embodiment of the oral tray 400 in FIG. 4 for ease of understanding. Similarly, the dimensionality and/or curvature of the second tray layer 404 have also been simplified in FIG. 4.

In particular, as shown in FIG. 4, the compartment can have a compartment length 407b. The compartment length 407a can vary depending on the design requirements of the oral tray 400, the recess 406, and/or the tooth conditioner 309. The compartment length 407a illustrated and described herein can be between approximately 0.01 mm and 10 mm. In various non-exclusive, alternative embodiments, the compartment width 407a can be approximately 0.01 mm, 0 mm, 0.05 mm, 0.1 mm, 0.15 mm, 0.2 mm, 0.25 mm, 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1 mm, 1.05 mm, 1.1 mm, 1.15 mm, 1.2 mm, 1.25 mm, 1.3 mm, 1.35 mm, 1.4 mm, 1.45 mm, 1.5 mm, 1.55 mm, 1.6 mm, 1.65 mm, 1.7 mm, 1.75 mm, 1.8 mm, 1.85 mm, 1.9 mm, 1.95 mm, 2 mm, 2.05 mm, 2.1 mm, 2.15 mm, 2.2 mm, 2.25 mm, 2.3 mm, 2.35 mm, 2.4 mm, 2.45 mm, 2.5 mm, 2.55 mm, 2.6 mm, 2.65 mm, 2.7 mm, 2.75 mm, 2.8 mm, 2.85 mm, 2.9 mm, 2.95 mm, 3 mm, 3.05 mm, 3.1 mm, 3.15 mm, 3.2 mm, 3.25 mm, 3.3 mm, 3.35 mm, 3.4 mm, 3.45 mm, 3.5 mm, 3.55 mm, 3.6 mm, 3.65 mm, 3.7 mm, 3.75 mm, 3.8 mm, 3.85 mm, 3.9 mm, 3.95 mm, 4 mm, 4.05 mm, 4.1 mm, 4.15 mm, 4.2 mm, 4.25 mm, 4.3 mm, 4.35 mm, 4.4 mm, 4.45 mm, 4.5 mm, 4.55 mm, 4.6 mm, 4.65 mm, 4.7 mm, 4.75 mm, 4.8 mm, 4.85 mm, 4.9 mm, 4.95 mm, 5 mm, 5.05 mm, 5.1 mm, 5.15 mm, 5.2 mm, 5.25 mm, 5.3 mm, 5.35 mm, 5.4 mm, 5.45 mm, 5.5 mm, 5.55 mm, 5.6 mm, 5.65 mm, 5.7 mm, 5.75 mm, 5.8 mm, 5.85 mm, 5.9 mm, 5.95 mm, 6 mm, 6.05 mm, 6.1 mm, 6.15 mm, 6.2 mm, 6.25 mm, 6.3 mm, 6.35 mm, 6.4 mm, 6.45 mm, 6.5 mm, 6.55 mm, 6.6 mm, 6.65 mm, 6.7 mm, 6.75 mm, 6.8 mm, 6.85 mm, 6.9 mm, 6.95 mm, 7 mm, 7.05 mm, 7.1 mm, 7.15 mm, 7.2 mm, 7.25 mm, 7.3 mm, 7.35 mm, 7.4 mm, 7.45 mm, 7.5 mm, 7.55 mm, 7.6 mm, 7.65 mm, 7.7 mm, 7.75 mm, 7.8 mm, 7.85 mm, 7.9 mm, 7.95 mm, 8 mm, 8.05 mm, 8.1 mm, 8.15 mm, 8.2 mm, 8.25 mm, 8.3 mm, 8.35 mm, 8.4 mm, 8.45 mm, 8.5 mm, 8.55 mm, 8.6 mm, 8.65 mm, 8.7 mm, 8.75 mm, 8.8 mm, 8.85 mm, 8.9 mm, 8.95 mm, 9 mm, 9.05 mm, 9.1 mm, 9.15 mm, 9.2 mm, 9.25 mm, 9.3 mm, 9.35 mm, 9.4 mm, 9.45 mm, 9.5 mm, 9.55 mm, 9.6 mm, 9.65 mm, 9.7 mm, 9.75 mm, 9.8 mm, 9.85 mm, 9.9 mm, 9.95 mm, or 10 mm. In other embodiments, the compartment width 407a can be greater than approximately 10 mm or less than approximately 0.01 mm.

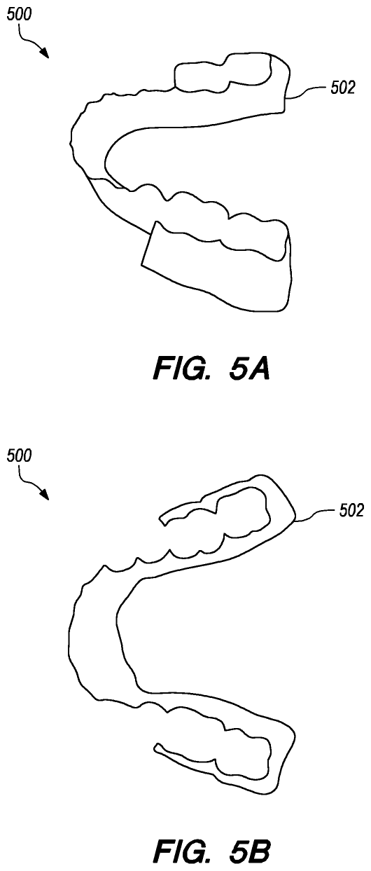

FIG. 5A is a simplified rear perspective view of a portion of the oral tray 500. In the embodiment illustrated in FIG. 5A, the first tray layer 502 is shown in one configuration. It is understood that the first tray layer 502 can vary in terms of dimensionality and form. For example, the first tray layer 502 can be configured to engage the hard palate, a portion of the interior sides of the teeth, and/or a portion of the exterior sides of one or more rear molars of the user's mouth. As used herein, the “exterior sides of the teeth” are understood to mean the facial (labial or buccal) surfaces of the teeth and/or the teeth that come into contact with portions of the user's face when the user's mouth is closed. Also, as used herein, “interior sides of the teeth” are understood to mean the lingual surfaces of the teeth and/or the surfaces that directly face the tongue. FIG. 5B is a simplified top view of the portion of the oral tray 500 shown in FIG. 5A. As shown in the embodiment illustrated in FIG. 5B, the first tray layer 502 can be configured to wrap around a portion of the user's rear molars. In other embodiments, the first tray layer 502 can be configured so that the first tray layer 502 is only in contact with non-molars.

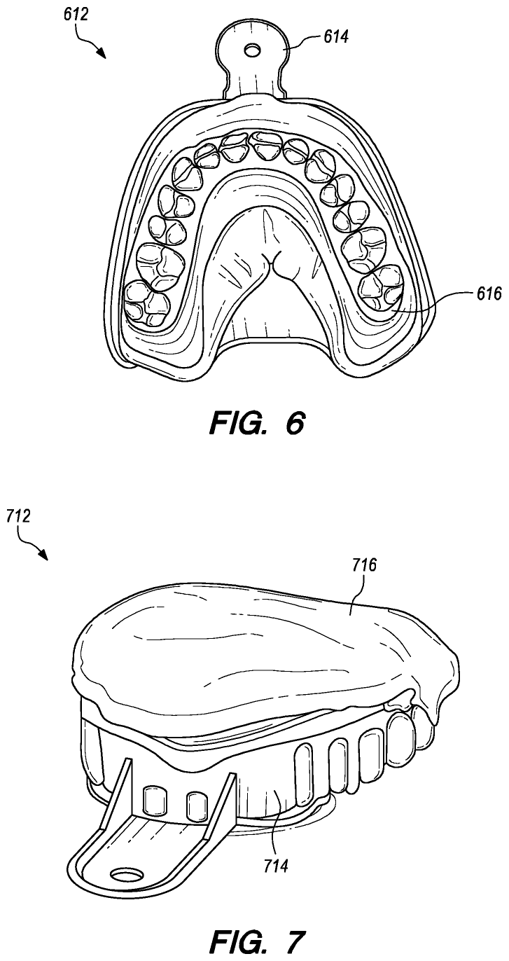

FIG. 6 is a top view of an impression tray 612, including an impression housing 614 and an impression material 616 used by one embodiment of a method for manufacturing the oral tray 100. As shown in the embodiment illustrated in FIG. 6, the impression tray 612 can be used to create impressions (shown in the impression material 616) that are in turn used to create models (e.g., model 108).

The impression tray 612 can vary depending on the design requirements of the oral tray 100, the model 108, and/or the impression material 616. It is understood that the impression tray 612 can include additional components, systems, subsystems, and elements other than those specifically shown and/or described herein. Additionally, or alternatively, the impression tray 612 can omit one or more of the components, systems, subsystems, and elements that are specifically shown and/or described herein.

The impression tray 612 can include an impression housing 614. The impression housing 614 can be configured to receive the impression material 616. The impression housing 614 can include a tab, a handle, and/or a grip that the user can grasp to assist in the manufacturing of the impression. The impression housing 614 can include holes and/or apertures that allow portions of the impression material 616 to escape through the holes and/or apertures when the user takes tooth impressions.

The impression material 616 can be any suitable material used to take teeth and/or mouth impressions. The impression material 616 can be formed (partially or fully) with one or more of the following materials: plasters, wax or impression compounds, Zinc oxide-eugenol, reversible hydrocolloids, agars, irreversible hydrocolloids, alginates, polysulfides, condensation silicones, addition silicones, and/or polyethers. Different impression materials 616 can be used at varying stages of the impression formation. For example, a first impression material 616 can be used to take the impression of the teeth, and a second impression material 616 can be poured into the impression to form the model 108. Any number of suitable impression materials 616 can be used to form the impression and/or model 108.

FIG. 7 is a front perspective view of another embodiment of an impression tray 712, including an impression housing 714 and an impression material 716 used by one embodiment of a method for manufacturing the oral tray 100. As shown in FIG. 7, the impression material 716 is shown in a hardened state. The impression material 716 can be trimmed as needed, including the removal of undercuts.

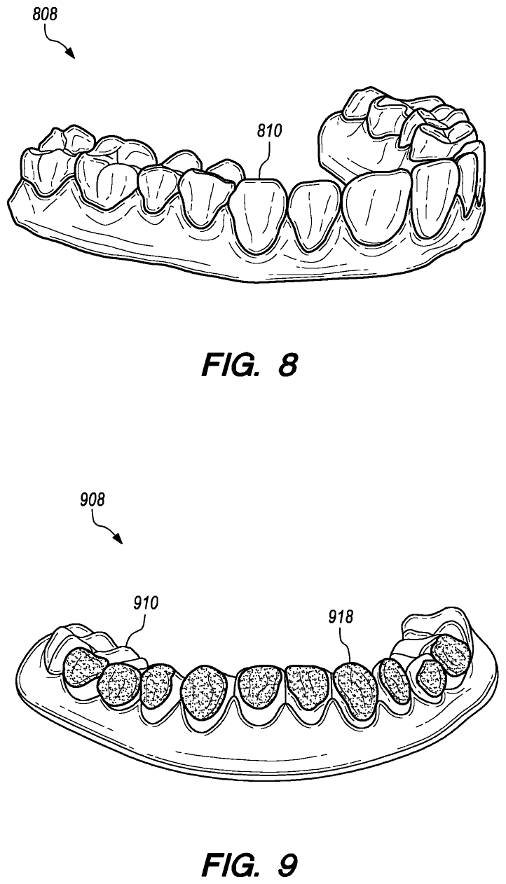

FIG. 8 is a front perspective view of a completed model 808 of a portion of the user's mouth and teeth 810 used by one embodiment of a method for manufacturing the oral tray 100. The model 808 can be a physical model, such as a plaster stone. In other embodiments, the model 808 can be a digital model that is created by scanning the impression taken within the impression tray 612. The model 808 can be scanned by a 3-D scanner. The model 808 can be a digital model that is created by directly scanning the teeth of the user.

FIG. 9 is a front view of a model 908 of a user's mouth including a plurality of spacers 918 used by one embodiment of a method for manufacturing the oral tray 100. The spacers 918 can be used to form the recess 106 in the second tray layer 104. The spacers 918 can vary depending on the design requirements of the oral tray 100, the second tray layer 104, the recess 106, the model 908, and/or the teeth 910. It is understood that the spacers 918 can include additional components, systems, subsystems, and elements other than those specifically shown and/or described herein. Additionally, or alternatively, the spacers 918 can omit one or more of the components, systems, subsystems, and elements that are specifically shown and/or described herein. The dimensionality of the spacers 918 can vary.

The spacers 918 can be positioned in any suitable position, including the positioning shown in the embodiment illustrated in FIG. 9. In some embodiments, the spacers 918 can be placed on a front face (e.g., the tooth face 111) of each corresponding tooth 910 so that the circumference of each spacer 918 has an approximately 0.5 mm margin around the outer circumference of the exterior side of each corresponding tooth 910. In certain embodiments, the margin between the circumference of each spacer 918 and the outer circumference of the exterior side of each corresponding tooth 910 illustrated and described herein can be between approximately 0.01 mm and 2.00 mm . In some such non-exclusive embodiments, the margin between the circumference of each spacer 918 and the outer circumference of the exterior side of each corresponding tooth 910 can be approximately 0.01 mm, 0.02 mm, 0.03 mm, 0.04 mm, 0.05 mm, 0.06 mm, 0.07 mm, 0.08 mm, 0.09 mm, 0.1 mm, 0.11 mm, 0.12 mm, 0.13 mm, 0.14 mm, 0.15 mm, 0.16 mm, 0.17 mm, 0.18 mm, 0.19 mm, 0.2 mm, 0.21 mm, 0.22 mm, 0.23 mm, 0.24 mm, 0.25 mm, 0.26 mm, 0.27 mm, 0.28 mm, 0.29 mm, 0.3 mm, 0.31 mm, 0.32 mm, 0.33 mm, 0.34 mm, 0.35 mm, 0.36 mm, 0.37 mm, 0.38 mm, 0.39 mm, 0.4 mm, 0.41 mm, 0.42 mm, 0.43 mm, 0.44 mm, 0.45 mm, 0.46 mm, 0.47 mm, 0.48 mm, 0.49 mm, 0.5 mm, 0.51 mm, 0.52 mm, 0.53 mm, 0.54 mm, 0.55 mm, 0.56 mm, 0.57 mm, 0.58 mm, 0.59 mm, 0.6 mm, 0.61 mm, 0.62 mm, 0.63 mm, 0.64 mm, 0.65 mm, 0.66 mm, 0.67 mm, 0.68 mm, 0.69 mm, 0.7 mm, 0.71 mm, 0.72 mm, 0.73 mm, 0.74 mm, 0.75 mm, 0.76 mm, 0.77 mm, 0.78 mm, 0.79 mm, 0.8 mm, 0.81 mm, 0.82 mm, 0.83 mm, 0.84 mm, 0.85 mm, 0.86 mm, 0.87 mm, 0.88 mm, 0.89 mm, 0.9 mm, 0.91 mm, 0.92 mm, 0.93 mm, 0.94 mm, 0.95 mm, 0.96 mm, 0.97 mm, 0.98 mm, 0.99 mm, 1 mm, 1.01 mm, 1.02 mm, 1.03 mm, 1.04 mm, 1.05 mm, 1.06 mm, 1.07 mm, 1.08 mm, 1.09 mm, 1.1 mm, 1.11 mm, 1.12 mm, 1.13 mm, 1.14 mm, 1.15 mm, 1.16 mm, 1.17 mm, 1.18 mm, 1.19 mm, 1.2 mm, 1.21 mm, 1.22 mm, 1.23 mm, 1.24 mm, 1.25 mm, 1.2 6mm, 1.27 mm, 1.28 mm, 1.29 mm, 1.3 mm, 1.31 mm, 1.32 mm, 1.33 mm, 1.3 4mm, 1.35 mm, 1.36 mm, 1.37 mm, 1.38 mm, 1.39 mm, 1.4 mm, 1.41 mm, 1.42 mm, 1.43 mm, 1.44 mm, 1.45 mm, 1.46 mm, 1.47 mm, 1.48 mm, 1.49 mm, 1.5 mm, 1.51 mm, 1.52 mm, 1.53 mm, 1.54 mm, 1.55 mm, 1.56 mm, 1.57 mm, 1.58 mm, 1.59 mm, 1.6 mm, 1.61 mm, 1.62 mm, 1.63 mm, 1.64 mm, 1.65 mm, 1.66 mm, 1.67 mm, 1.68 mm, 1.69 mm, 1.7 mm, 1.71 mm, 1.72 mm, 1.73 mm, 1.74 mm, 1.75 mm, 1.76 mm, 1.77 mm, 1.78 mm, 1.79 mm, 1.8 mm, 1.81 mm, 1.82 mm, 1.83 mm, 1.84 mm, 1.85 mm, 1.86 mm, 1.87 mm, 1.88 mm, 1.89 mm, 1.9 mm, 1.91 mm, 1.92 mm, 1.93 mm, 1.94 mm, 1.95 mm, 1.96 mm, 1.97 mm, 1.98 mm, 1.99 mm, or 2 mm. In other embodiments, the margin between the circumference of each spacer 918 and the outer circumference of the exterior side of each corresponding tooth 910 can be greater than approximately 2.00 mm or less than approximately 0.01 mm.

The spacers 918 can be placed on any tooth 910. In some embodiments, the spacers 918 are placed only on non-molars. In other embodiments, the spacers 918 are placed on every tooth 910 except the last two molars (as shown in FIG. 9). In certain embodiments, the spacers 918 are only placed on the teeth 910 that are visible when the user smiles. The spacers 918 can be hand-painted onto the teeth 910 of a physical model 908 (e.g., stone formed).

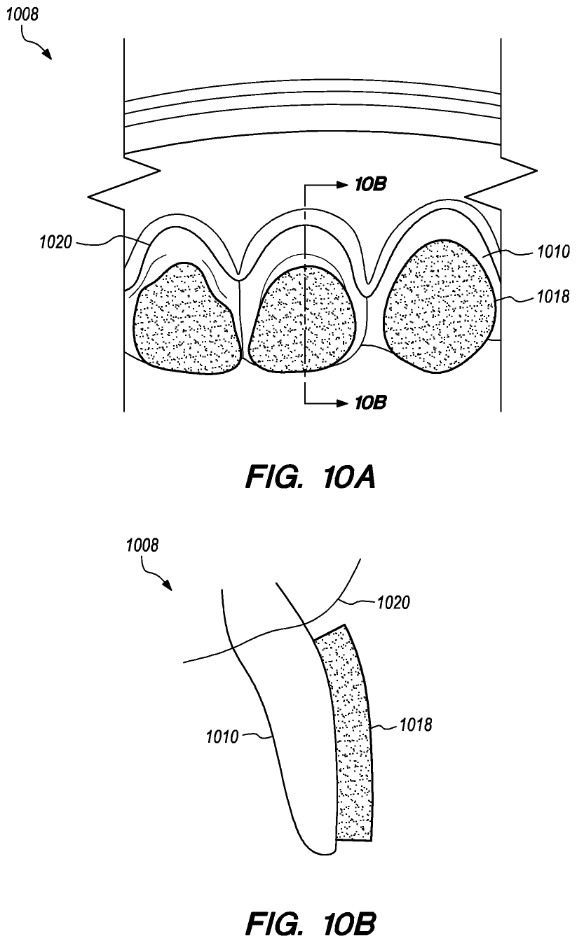

FIG. 10A is a simplified front view of a model 1008 of a user's mouth including a plurality of spacers 1018 used by one embodiment of a method for manufacturing the oral tray 100. FIG. 10B is a simplified cross-sectional view illustration of the model 1008 of the user's mouth taken on line 10B-10B in FIG. 10A. In the embodiment shown in FIGS. 10A and 10B, the margin between the spacers 1018 and a gum line 1020 is shown in detail. As shown in FIGS. 10A and 10B, the spacers 1018 can be customized to match the user's individual teeth 1010. In other embodiments, the spacers 1018 are formed so that the recesses are substantially convex on one side and substantially concave on the opposing side.

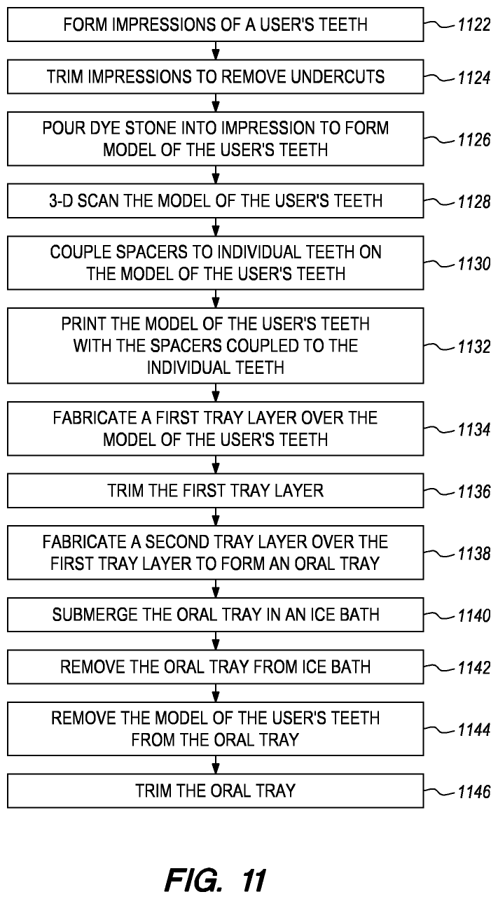

FIG. 11 is a flowchart outlining one embodiment of a method for manufacturing the oral tray. It is understood that the method pursuant to the disclosure herein can include greater or fewer steps than those shown and described relative to FIG. 11. Stated another way, the method according to the present invention can omit one or more steps illustrated in FIG. 11, or can add additional steps not shown and described in FIG. 11, and still fall within the purview of the present invention. Further, the sequence of the steps can be varied from those shown and described relative to FIG. 11. The sequence of steps illustrated in FIG. 11 is not intended to limit the sequencing of steps in any manner.

In the embodiment illustrated in FIG. 11, at step 1122, impressions are formed of a user's teeth. The impressions can include areas around the user's teeth, such as the user's oral cavity, the user's soft tissue, and/or the user's bite relations between the user's top teeth and the user's bottom teeth. Impressions can be taken of the user's top teeth and the user's bottom teeth. A first impression material and a second impression material can be combined to create a third impression material. It should be noted that any number of suitable impression materials can be combined to create the third impression material. In some embodiments, the impression materials are hand combined by the user to create the third impression material.

The third impression material can be rolled into a format suitable for the impression tray. The third impression material can be compacted into the impression housing of the impression tray. When the third impression material is inserted into the impression housing, the user can press the third impression material into the impression housing to secure the third impression material in the impression housing. In some embodiments, the user uses two fingers to press the third impression material in the front portion of the impression tray (near where the front teeth contact the third impression material).

When the user takes the first impressions of their teeth, the user can grip a handle of the impression housing. The user then places the impression tray over the user's bottom teeth or the user's top teeth. Next, the user bites down onto the third impression material. The user can pull their lip around the impression housing.

The user can continue biting into the third impression material for approximately 90 seconds. It is understood that the impression-taking procedure may be shorter than 90 seconds or longer than 90 seconds, depending on the third impression material and other conditions. The user can remove the impression tray from their mouth after the first impression is taken.

After the user has finished taking the first impressions in the third impression material, the user can fill the first impressions of the user's teeth with a fourth impression material. The user can use a distribution device, such as a syringe, to spread the fourth impression material throughout the first impressions of the user's teeth. In some embodiments, the fourth impression material is distributed to the first impressions of the user's front teeth before distributing the fourth impression material to the first impression of the user's rear teeth.

After the fourth impression material is fully distributed within the first impression, the user can place the impression tray back in their mouth using a similar method as described with respect to the first impression. The user can continue biting into the fourth impression material for approximately 90 seconds to take a second impression. It is understood that the impression taking may take longer than 90 seconds, depending on the fourth impression material and other conditions. The user can remove the impression tray from their mouth after the second impression is taken. The first impression and second impression processes described herein can be repeated any number of times for the user's top and bottom teeth.

At step 1124, the impressions are trimmed to remove portions of the impressions, including undercuts. Any undesired portion of the impressions can be removed by cutting, trimming, and/or any suitable removal method that is known in the art. The impressions so that the oral tray that is manufactured by utilizing the impressions is more comfortable for any given user.

At step 1126, dye stone (or an alternative teeth modeling material) is poured into the impression to form a model of the user's teeth. After the dye stone (or an alternative teeth modeling material) has fully hardened, the stone model is removed from the impression. The model of the user's teeth can be allowed to fully harden and/or cure before moving on to step 1128.

At step 1128, the model of the user's teeth is 3-D scanned. In other embodiments, the 3-D scanner can directly scan the impressions without the need to pour dye stone (or an alternative teeth modeling material) into the impression. Upon completion of the 3-D scan, a digital 3-D model is created of the user's teeth and gums is created.

At step 1130, spacers (e.g., the spacer that forms the compartment between the recess 106 and the tooth face 111) are coupled to individual teeth on the model of the user's teeth. On the digital 3-D model, each tooth can be selected individually. Using the individual teeth on the 3-D model, the entirety of an enamel face of an individual tooth can be selected. Digital spacers can be digitally coupled to the enamel face of each individual tooth while leaving a margin around an outer circumference of the tooth and/or gum line. The spacer margin on the digital 3-D model can be the same or similar to the margin described with respect to FIG. 9 herein. Using the digital 3-D model, the spacer size can be verified to ensure that each recess is configured to retain the same amount of tooth conditioner.

In some embodiments, instead of digitally adding and scanning the spacers to the individual teeth in the 3-D model, the spacers can be coupled to the stone (physical) model of the user's teeth. The physical spacers can be painted onto the individual teeth of the stone (physical) model.

The spacers can be coupled to the individual teeth of the model so that the spacers have a spacer thickness is greater than 0.10 mm and less than 2.20 mm. In some embodiments, the spacer thickness is greater than 1.00 mm and less than 1.20 mm. The spacers can be formed so that the recesses have any suitable shape (such as described herein). The spacers can have one or more substantially straight spacer walls. The spacers can be substantially convex or concave in shape. The spacers can be formed so that they conform with a curvature of the teeth.

At step 1132, the model of the user's teeth with the coupled spacers is printed. The model of the user's teeth can be printed by a 3-D printer. The printed model can be printed using any suitable printing materials, including but not limited to resins, plastics, and/or composites.

At step 1134, a first tray layer is fabricated over the printed model of the user's teeth with the coupled spacers. In some embodiments, the first tray layer is heated to a temperature so that the first tray layer melts around the printed model of the user's teeth. A suction force can be applied to the first tray layer so that the first tray layer becomes sealed around the printed model of the user's teeth. In various embodiments, the oral tray can be produced by pressure forcing the first tray layer over a physical model, then pressure forcing the second tray layer over the first tray layer and the physical model.

At step 1136, the first tray layer is trimmed to remove portions of the first tray layer, including undercuts. A similar example of a trimmed first tray layer is displayed in the embodiments shown in FIGS. 5A, 5B. In some embodiments, portions of the first tray layer are trimmed so that the occlusal plane of the user's teeth is uncovered if the first tray layer were in contact with the user's teeth. In some embodiments, the first layer is in contact with the entirety of the occlusal plane of the user's teeth if the first tray layer were in contact with the user's teeth. In other embodiments, portions of the first tray layer are trimmed so that the first tray layer only covers the occlusal plane of the user's teeth if the first tray layer were in contact with the user's teeth. In certain embodiments, portions of the first tray layer are trimmed so that the faces of any non-molar are uncovered if the first tray layer were in contact with the user's teeth.

At step 1138, a second tray layer is fabricated over the first tray layer to form the oral tray. In some embodiments, the second tray layer is heated to a temperature so that the second tray layer melts around the printed model of the user's teeth and the first tray layer. A suction force can be applied to the second tray layer to seal the second tray layer around the printed model of the user's teeth and the first tray layer.

At step 1140, the oral tray is submerged into an ice bath. By lowering the temperature of the oral tray, a coupling force between the first tray layer and the second tray layer hardens. The oral tray can be submerged in the ice bath until the desired coupling force between the first and second tray layers is obtained. In other embodiments, the oral tray can be submerged into the ice bath for any suitable amount of time.

At step 1142, the oral tray is removed from the ice bath. Any water or moisture remaining on the oral tray is then removed. In some embodiments, the oral tray is given a suitable amount of time to dry before proceeding to step 1144.

At step 1144, the model of the user's teeth is removed from the oral tray. Any water or moisture that remains after the removal of the model of the user's teeth is then removed. In other embodiments, the oral tray is given a suitable amount of time to dry before proceeding to step 1146.

At step 1146, the oral tray is trimmed to remove portions of the oral tray, including undercuts. The oral tray can also be trimmed straight across with respect to a gum line of the users. In other embodiments, the oral tray can be trimmed so that the oral tray is scalloped with respect to the gum line of the user. Further, the oral tray can be trimmed to follow the gum line of the user.

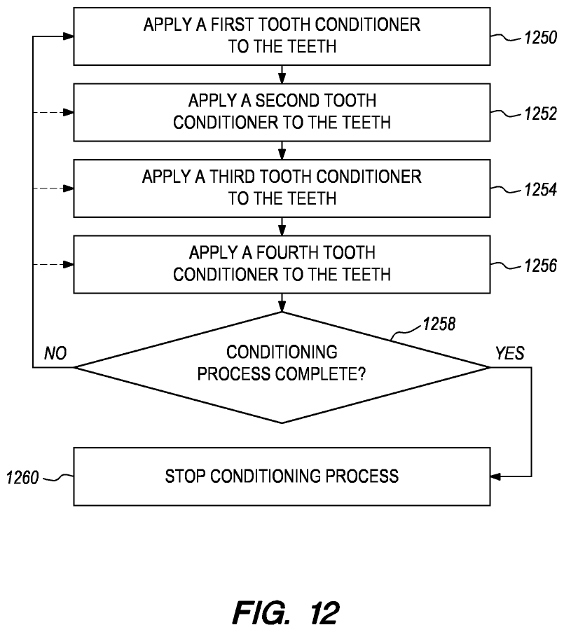

FIG. 12 is a flowchart outlining one embodiment of a method for conditioning of a user's teeth. It is understood that the method pursuant to the disclosure herein can include greater or fewer steps than those shown and described relative to FIG. 12. Stated another way, the method according to the present invention can omit one or more steps illustrated in FIG. 12, or can add additional steps not shown and described in FIG. 12, and still fall within the purview of the present invention.

Further, the sequence of the steps can be varied from those shown and described relative to FIG. 12. The sequence of steps illustrated in FIG. 12 is not intended to limit the sequencing of steps in any manner. It is recognized that the sequence of steps illustrated in FIG. 12 can be customized to the user depending on the individual user's level of oral and/or teeth sensitivities, desired oral and/or teeth conditioning results, and the user's personalized conditioning schedule. The method shown and described relative to FIG. 12 can include customizing the application of the tooth conditioners to the mouth of the user, depending upon the extent of the conditioning, whitening, and/or strengthening desired for a particular user. Additionally, it is understood that varying concentrations of tooth conditioners can be used by the method of conditioning a user's teeth, as described herein.

In certain embodiments, such as the method illustrated in FIG. 12, any suitable tooth conditioner can be used. For example, in non-limiting, non-exclusive embodiments, the tooth conditioners can be whiteners of different concentrations, strengtheners of different concentrations that strengthen and/or improve the structure and/or function of the tooth, oral disease treatments of different concentrations, tooth cleansers of different concentrations, and/or mouth cleansers of different concentrations. In some embodiments, the tooth conditioners can include hydrogen peroxide derivatives, alternative whitening modalities, enamel strengtheners, desensitizing agents, antibiotics, fluorides, whitening gels, whitening composites, gum disease treatments, and/or adenoid cystic carcinoma (ACC) treatments.

By utilizing varying concentrations of tooth conditioners, a number of advantages are realized. With respect to teeth whitening, stain molecules on the teeth of the user are more efficiently treated by varying concentrations of whiteners, depending on the intensity of the stain molecules and the depth of the stain molecules within the tooth.

In some embodiments, chromophores respond better to a particular type of peroxide. For example, to fully break apart chromophores, it may require using a range of concentrations of peroxides. In non-exclusive embodiments, it may take less than 35% and greater than 10% carbamide peroxide to break apart chromophores. In other embodiments, it may take greater than 35% or less than 10% carbamide peroxide to break apart chromophores. If molecular bonds between the chromophores can be fully broken, the resulting color (e.g., whitening) of the teeth has greater stability.

Specific concentrations of whitening gel (e.g., 35% carbamide peroxide) can effectively remove stains close to the surface of the tooth. However, such concentrations of peroxide are unable to penetrate deeply into the tooth because they should only be applied to the enamel for a short period of time. More prolonged application of specific concentrations of peroxide can damage the microhardness of the enamel. Alternatively, 10% carbamide peroxide can penetrate deeply into the tooth because it can be applied for an extended period of time (in some embodiments, up to 12 hours).

In the embodiment illustrated in FIG. 12, at step 1250, a first tooth conditioner is applied to the user's teeth. The embodiment illustrated in FIG. 12 for conditioning the user's teeth can be used in combination with any of the oral tray(s) described herein to provide improved conditioning of the user's teeth. The tooth conditioners can be applied to the user's teeth using any suitable application method. In one non-limiting, non-exclusive example, the tooth conditioners can be brushed onto the user's teeth. In other examples, the tooth conditioners can be applied to any suitable oral device (such as the oral trays described herein) to be worn by the user.

It is appreciated that the first tooth conditioner described herein can be applied for any given length of time. In some non-exclusive, non-limiting embodiments, the first tooth conditioner can be applied to the user's teeth for an entire morning, afternoon, evening, or night (e.g., between 6-12 hours). In certain embodiments, the first tooth conditioner can be applied to the user's teeth between 0.1 hours and 6 hours. In various embodiments, the first tooth conditioner described herein can be applied for an entire day, a week, or up to a month. In other embodiments, the first tooth conditioner can be applied for less than 0.1 hours or greater than 1 month.

At step 1252, a second tooth conditioner is applied to the teeth of the user. It is appreciated that the second tooth conditioner described herein can be applied for any given length of time. In some non-exclusive, non-limiting embodiments, the second tooth conditioner can be applied to the user's teeth for an entire morning, afternoon, evening, or night (e.g., between 6-12 hours). In certain embodiments, the second tooth conditioner can be applied to the user's teeth between 0.1 hours and 6 hours. In various embodiments, the second tooth conditioner described herein can be applied for an entire day, a week, or up to a month. In other embodiments, the second tooth conditioner can be applied for less than 0.1 hours or greater than 1 month.

At step 1254, a third tooth conditioner is applied to the teeth of the user. It is appreciated that the third tooth conditioner described herein can be applied for any given length of time. In some non-exclusive, non-limiting embodiments, the third tooth conditioner can be applied to the teeth of the user for an entire morning, afternoon, evening, or night (e.g., between 6-12 hours). In various embodiments, the third tooth conditioner described herein can be applied for an entire day, a week, or up to a month. In other embodiments, the third tooth conditioner can be applied for less than 6 hours.

At step 1256, a fourth tooth conditioner is applied to the teeth of the user. It is appreciated that the fourth tooth conditioner described herein can be applied for any given length of time. In some non-exclusive, non-limiting embodiments, the fourth tooth conditioner can be applied to the teeth of the user for an entire morning, afternoon, evening, or night (e.g., between 6-12 hours). In various embodiments, the fourth tooth conditioner described herein can be applied for an entire day, a week, or up to a month. In other embodiments, the fourth tooth conditioner can be applied for less than 6 hours.

At step 1258, if the teeth conditioning process is not complete, steps 1250 through 1256 will be repeated. While the solid arrow from step 1258 to 1250 indicates that the conditioning process will be repeated starting with step 1250, the dashed arrows indicate that any of the steps 1250 through 1256 can be the starting point for the next cycle of teeth conditioning. In some embodiments, steps 1250 through 1256 can be performed in any order, and some steps can be omitted. Alternatively, the next cycle of teeth conditioning can include additional steps not shown in FIG. 12.

At step 1260, if the teeth conditioning process has been completed, the conditioning of the teeth is halted. While the teeth conditioning process is completed at step 1260, it is appreciated that the method for conditioning the user's teeth can be restarted depending on the conditioning and/or treatment requirements of the individual user.

While the method shown and described relative to FIG. 12 includes four tooth conditioners, any suitable number of tooth conditioners can be used. For example, be fewer than four tooth conditioners can be used, greater than four tooth conditioners can be used, or only four tooth conditioners can be used. The use of four tooth conditioners is provided for ease of explanation and is not intended to limit the scope of the invention in any manner. It is appreciated that any additional tooth conditioners can be applied for any given length of time. In some non-exclusive, non-limiting embodiments, any additional tooth conditioners can be applied to the teeth of the user for an entire morning, afternoon, evening, or night (e.g., between 6-12 hours). In various embodiments, any additional tooth conditioners can be applied for an entire day, a week, or up to a month. In other embodiments, any additional tooth conditioners can be applied for less than 6 hours.

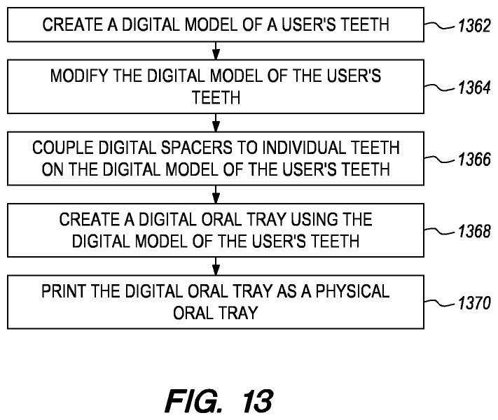

FIG. 13 is a flowchart outlining one embodiment of a method for manufacturing the oral tray. It is understood that the method pursuant to the disclosure herein can include greater or fewer steps than those shown and described relative to FIG. 13. Stated another way, the method according to the present invention can omit one or more steps illustrated in FIG. 13, or can add additional steps not shown and described in FIG. 13, and still fall within the purview of the present invention. Further, the sequence of the steps can be varied from those shown and described relative to FIG. 13. The sequence of steps illustrated in FIG. 13 is not intended to limit the sequencing of steps in any manner.

In the embodiment illustrated in FIG. 13, at step 1362, a digital model of a user's teeth is created. To create the digital model of a user's teeth, an imager can be used. As used herein, the “imager” is understood to mean any suitable device used to create the digital model of the user's teeth. Non-limiting, non-exclusive examples of suitable imagers include scanners, modelers, imaging systems (digital and physical), and/or cameras/ In some embodiments, a 3-D imager can be used to scan the user's teeth and gums to create the digital model of the user's teeth and gums. In other embodiments, the digital model can be created by scanning an impression taken within an impression tray. The digital model of the user's teeth and gums can be in the form of a stereolithography CAD file, such as a .STL file.

The digital model created by the imager can be a 3-D computer-aided design model. By utilizing the imager, various advantages are realized, such as increased speed of model creation. In certain applications, the imager can create the digital model of the user's teeth and gums within seconds after scanning. The digital model of the user's teeth and gums can be quickly updated with successive digital scans, thereby improving the accuracy of the digital model and the physical oral tray that is produced by utilizing the digital model.

At step 1364, the digital model of the user's teeth is modified. The digital model can be modified in a 3-D computer-aided design program to fit the user's needs. For example, the outer perimeter or edge of the digital model can be straightened and/or smoothed. Any suitable dimensionality of the digital model can be modified, including but not limited to scale and thickness.

At step 1366, the digital spacers are coupled to individual teeth on the digital model of the user's teeth. The digital spacers can be added to the digital model of the user's teeth within the 3-D computer-aided design program. In some embodiments, the digital spacers are automatically added to the digital model of the user's teeth based on at least some of the parameters described herein with respect to the physical spacers 918.

At step 1368, a digital oral tray is created using the digital model of the user's teeth. The digital oral tray can be created by conforming to the curvature of the digital model of the user's teeth within the 3-D computer-aided design program. In some embodiments, the digital oral tray is automatically formed around the digital model of the user's teeth within the 3-D computer-aided design program.

At step 1370, the digital oral tray is printed as a physical oral tray. The digital oral tray can be printed as the physical oral tray using any suitable printing methods known in the art. In one example, the digital oral tray can be printed using a 3-D printer. The physical oral tray can be polished and/or trimmed, as needed.

In non-exclusive, non-limiting embodiments, the various components of the physical oral tray can be printed by the 3-D printer using one or more printable resins. For example, a first tray layer can be 3-D printed using a first resin. Then, a second tray layer can be 3-D printed onto the first tray layer using a second resin that is more flexible and/or less stiff than the first resin as previously more fully described herein. Alternatively, the first tray layer and the second tray layer can be printed simultaneously using at least two types of printable resins, printable materials, and/or milling materials. In some embodiments, the various components of the physical oral tray can be milled, sculpted, and/or cut from a milling material using any suitable milling device.

It is understood that although a number of different embodiments of an oral tray, methods of manufacturing the oral tray, and methods for tooth conditioning have been illustrated and described herein, one or more features of any one embodiment can be combined with one or more features of one or more of the other embodiments, provided that such combination satisfies the intent of the present invention.

While a number of exemplary aspects and embodiments of the oral tray, methods of manufacturing the oral tray, and methods for tooth conditioning have been shown and disclosed hereinabove, those of skill in the art will recognize certain modifications, permutations, additions, and sub-combinations thereof. It is therefore intended that the present invention shall be interpreted to include all such modifications, permutations, additions, and sub-combinations as are within their true spirit and scope, and no limitations are intended to the details of construction or design herein shown.

What is claimed is:

1. A method for conditioning teeth within a mouth of a user, the method comprising the steps of:
applying a first tooth conditioner to an oral tray for use on the teeth within the mouth of the user for a first application time; and
subsequently applying a second tooth conditioner to the oral tray for use on the teeth within the mouth of the user for a second application time, the second tooth conditioner having a different chemical composition than the first tooth conditioner.

2. The method of claim 1 wherein the second application time is different than the first application time.

3. The method of claim 1 wherein the second application time is the same as the first application time.

4. The method of claim 1 further comprising the step of subsequently applying a third tooth conditioner to the oral tray for use on the teeth within the mouth of the user for a third application time, the third tooth conditioner having a different chemical composition than the first tooth conditioner and the second tooth conditioner.

5. The method of claim 4 further comprising the step of subsequently applying a fourth tooth conditioner to the oral tray for use on the teeth within the mouth of the user for a fourth application time, the fourth tooth conditioner having a different chemical composition than the first tooth conditioner, the second tooth conditioner, and the third tooth conditioner.

6. The method of claim 1 wherein the application times are greater than 0.1 hours and less than 6.0 hours.

7. The method of claim 1 wherein the tooth conditioners include one or more of whiteners, strengtheners, oral disease treatments, tooth cleansers, and mouth cleansers.

8. The method of claim 1 wherein the tooth conditioners include one or more of hydrogen peroxide derivatives, alternative whitening modalities, enamel strengtheners, desensitizing agents, antibiotics, fluorides, whitening gels, whitening composites, gum disease treatments, and adenoid cystic carcinoma treatments.

9. The method of claim 1 wherein at least one of the tooth conditioners includes a whitening gel with greater than 10% carbamide peroxide and less than 35% carbamide peroxide.

10. A method for conditioning teeth within a mouth of a user, the method comprising the steps of:
applying a first tooth conditioner to an oral tray for use on the teeth within the mouth of the user for a first application time; and
subsequently applying a second tooth conditioner to the oral tray for use on the teeth within the mouth of the user for a second application time that is different than the first application time.

11. The method of claim 10 further comprising the step of subsequently applying a third tooth conditioner to the oral tray for use on the teeth within the mouth of the user for a third application time that is different than the first application time and the second application time.

12. The method of claim 11 further comprising the step of subsequently applying a fourth tooth conditioner to the oral tray for use on the teeth within the mouth of the user for a fourth application time that is different than the first application time, the second application time, and the third application time.

13. The method of claim 12 wherein the tooth conditioners have different chemical compositions

14. The method of claim 10 wherein the application times are greater than 0.1 hours and less than 6.0 hours.

15. The method of claim 10 wherein at least one of the tooth conditioners includes a whitening gel with greater than 10% carbamide peroxide and less than 35% carbamide peroxide.

16. The method of claim 10 wherein the first tooth conditioner is a whitener.

17. The method of claim 16 wherein the second tooth conditioner is a strengthener.

18. The method of claim 10 wherein the oral tray includes (i) a first tray layer that is configured to engage the teeth within the mouth of the user, and (i) a second tray layer that is coupled to the first tray layer, the second tray layer having a plurality of tooth portions each including a recess, each recess being configured to receive the tooth conditioners.

19. The method of claim 18 wherein the first tray layer has a first tray thickness of greater than 0.01 mm and less than 2.00 mm , and the second tray layer has a second tray thickness of greater than 0.01 mm and less than 2.00 mm .

20. A method for conditioning teeth within a mouth of a user, the method comprising the steps of:
applying a first tooth conditioner to an oral tray for use on the teeth within the mouth of the user for a first application time, the oral tray including (i) a first tray layer that is configured to engage the teeth within the mouth of the user, and (i) a second tray layer that is coupled to the first tray layer;
subsequently applying a second tooth conditioner to the oral tray for use on the teeth within the mouth of the user for a second application time that is different than the first application time, the second tooth conditioner having a different chemical composition than the first tooth conditioner; and
subsequently applying a third tooth conditioner to the oral tray for use on the teeth within the mouth of the user for a third application time that is different than the first application time and the second application time;
wherein the first tooth conditioner and the second tooth conditioner include whiteners, and wherein the third tooth conditioner includes a strengthener.
